(19) United States
(12) Patent Application Publication
(10) Pub. No.: US 2025/0212865 A1
(43) Pub. Date: Jul. 3, 2025

(54) Method for Distributing Spray onto an Agricultural Area, and Agricultural Spray Device

(71) Applicant: Amazonen-Werke H. Dreyer Se & Co. Kg, Hasbergen (DE)

(72) Inventor: Maik WERMELING, Rheine (DE)

(73) Assignee: Amazonen-Werke H. Dreyer SE & Co. KG, Hasbergen (DE)

(21) Appl. No.: 18/851,528

(22) PCT Filed: Mar. 16, 2023
(86) PCT No.: PCT/EP2023/056694

§ 371 Date: Sep. 26, 2024

(30) Foreign Application Priority Data
Mar. 30, 2022 (DE) 10 2022 107 504.4

(51) Int. Cl. A01M 7/00; A01C 23/00; A01C 23/04

(52) U.S. Cl. CPC A01M 7/0042; A01C 23/007; A01C 23/047; A01M 7/0089

(57) ABSTRACT

A method for distributing spray onto an agricultural area by means of an agricultural spray device, in which the spray is conveyed by means of at least one conveying device along at least one liquid circuit of the spray device, wherein a conveying quantity and/or conveying pressure, with which the spray is conveyed at least in portions along the liquid circuit, is set on the basis of at least one operating parameter which can be set on the conveying device, wherein the spray is distributed onto the agricultural area via a plurality of distributing elements which are arranged along the liquid circuit and are each configured to set a distributing quantity of the spray on the basis of the opening times which can be set at the distributing elements. In order to design a method for distributing spray in such a way that the machine-internal conveying of the spray and/or the operation of the at least one conveying device are/is improved further, it is provided that the at least one operating parameter of the conveying device is open-loop and/or closed-loop controlled on the basis of the adjustable opening times of the distributing elements.

### CROSS REFERENCE TO RELATED APPLICATIONS

The present application claims priority under 35 U.S.C. § 365 to PCT/EP2023/056694 filed on Mar. 16, 2023 and under 35 U.S.C. § 119 to German Application No. 10 2022 107 504.4 filed on Mar. 30, 2022.

### BACKGROUND

The disclosure relates to a method for distributing spray onto an agricultural area and an agricultural spray device.

Trailed, carried and/or self-propelled spray devices, such as field sprayers, are regularly used for distributing spray to agricultural land. Depending on requirements, the spray is often designed as a liquid fertilizer, plant protection agent, weed killer, pesticide or the like, and is usually distributed or applied over a large area or selectively via a plurality of distributing elements, in particular spray nozzles, which are arranged on the spray device. On modern agricultural spray devices, the spray is distributed for this purpose by means of distributing elements, each of which is designed to adjust a distribution quantity of the spray, preferably as required and/or site-specific, by means of opening times that can be set on the distributing elements, in particular a pulse duration or a duty cycle.

In order to provide spray to the respective distributing elements as required for this purpose, the spray is usually conveyed along at least one fluid circuit of the spray device, on which the distributing elements are arranged or to which the distributing elements are connected in a fluid-conducting manner, by means of at least one conveying device, in particular a pump device, assigned to the spray device.

A generic agricultural spray device and a corresponding method for distributing spray are also known, for example, from the publication EP 2 153 710 A2. A corresponding delivery rate and/or a delivery pressure, with which the spray is conveyed at least in portions along the liquid circuit, is set on the basis of at least one operating parameter that can be set on the conveying device, in particular by means of an adjustable rotation speed of the conveying device. The spray provided in this way is then distributed to the agricultural area via a plurality of distributing elements arranged along the liquid circuit.

### SUMMARY

However, spray devices and/or methods that can be operated in this way have so far the disadvantage, that the at least one adjustable operating parameter, in particular the rotation speed, of the conveying device is always, in particular only, open-loop and/or closed-loop controlled as a function of at least one control element arranged along the liquid circuit, which is designed in particular in the manner of a central control valve or flow control valve, and/or as a function of a travel speed of the spray device. However, such an open-loop control and/or closed-loop control of the at least one operating parameter of the conveying device has proven to be insufficient in practice.

Thus, the object underlying the disclosure is to design a method for distributing spray in such a way that the machine-internal conveying of the spray and/or the operation of the at least one conveying device is further improved. In particular, a method is to be provided by which the at least one operating parameter, preferably the rotation speed, of the conveying device is optimally controlled.

In accordance with the disclosure, this object is solved in that the at least one operating parameter, in particular the rotation speed, of the conveying device is open-loop controlled and/or closed-loop controlled on the basis of the adjustable opening times, in particular the pulse duration or the duty cycle, of the distributing elements, and preferably additionally on the basis of the delivery rate and/or the delivery pressure.

As a result of this measure, the at least one operating parameter, in particular the rotation speed, of the at least one conveying device is variable depending on the setting parameters, in particular the opening times or pulse durations, of the distributing elements. Preferably, the adjustable delivery quantities within the liquid circuit and/or the adjustable delivery pressures of the spray are also taken into account. The adjustable operating parameter, in particular the adjustable rotation speed, of the at least one conveying device is thus determined and/or predetermined as a function of at least one setting parameter of the distributing elements and preferably additionally on the basis of at least one further parameter, such as the travel speed of the spray device, a degree of opening of at least one actuator, a delivery rate and/or a delivery pressure of the spray. The at least one operating parameter of the conveying device can, for example, be stored and/or retrievable using an electronic function and/or an electronic characteristic map, which takes into account the at least one setting parameter of the distributing elements and preferably at least one further adjustable parameter. Such an embodiment ensures that the at least one conveying device, in particular pump device, is operated during distributing with an optimally adjusted operating parameter, in particular at an optimum rotation speed.

In a preferred embodiment, it may be provided that a determinable and/or predeterminable target flow rate of the spray is taken into account as delivery rate of the spray and/or a determinable and/or predeterminable target delivery pressure or target system pressure of the spray is taken into account as delivery pressure of the spray. In a particularly preferred embodiment, at least one measuring device is provided, in particular along the liquid circuit, which is designed to detect an actual flow rate and/or an actual delivery pressure or actual system pressure of the spray, whereby the actual flow rate and/or the actual delivery pressure is taken into account for open-loop and/or closed-loop controlling the operating parameter of the conveying device.

The distributing elements are preferably designed in the manner of valves and/or spray nozzles which can be switched, in particular switched quickly. However, the distributing elements are particularly preferably designed as spray nozzles, each of which is assigned to at least one valve, which is designed to release and/or block, in particular to closed-loop control, the distributing spray via the respective spray nozzle. Alternatively or additionally, a respective distributing element can also be designed in the form of a multiple nozzle body, each with several spray nozzles that can be switched on as required. In case of a distributing element designed as a multiple nozzle body, at least one valve can be assigned to several or all spray nozzles together or alternatively or additionally to each individual spray nozzle. Alternatively or additionally, such a distributing element can also be a valve, for example in the manner of a section width valve, which is assigned to a group of individual spray nozzles or a group of multiple nozzle bodies and is set up to open-loop control and/or closed-loop control the flow of the spray to the multiple spray nozzles or multiple nozzle bodies.

Furthermore, the distributing elements are preferably connected in a fluid-conducting manner via the fluid circuit to at least one reservoir of the spray device provided for holding the spray. The spray can be provided in at least partially premixed form, for example from at least one chemical and a carrier liquid, or alternatively in separate storage containers, whereby the separately provided liquids (chemical and carrier liquid) are combined or mixed in an adjustable manner along the liquid circuit to form the spray.

The conveying device, in particular the pump device, is preferably driven by means of at least one associated actuator. The actuator can be a hydraulically, pneumatically and/or electrically operated motor, which is arranged on the conveying device and/or connected to the conveying device. Alternatively or additionally, the pump device can also be driven by means of an external actuator, which is assigned to another machine or machine device, for example a towing vehicle. For example, a power take-off shaft drive can be provided between the towing vehicle and the spray device, which is designed to variably adjust the respective operating parameter, in particular the rotation speed, of the conveying device. Furthermore, the at least one conveying device is preferably designed as a liquid pump or spray pump, such as a piston diaphragm pump, centrifugal pump or the like. Furthermore, the at least one conveying device is preferably arranged between at least one storage container and the distributing elements, in particular along the liquid circuit. Alternatively or additionally, several such conveying devices within the spray device, in particular along the liquid circuit, would also be conceivable.

In a preferred embodiment of the method according to the disclosure, the distributing elements are open-loop and/or closed-loop controlled in the manner of a pulse width modulation and/or a pulse width frequency modulation. The distributing elements are preferably designed in the manner of so-called PWM nozzles or PWM valves with adjustable pulse width. Alternatively or additionally, the distributing elements can also be designed in the manner of so-called PWFM nozzles or PWFM valves with an additionally adjustable pulse frequency. Such distributing elements are set up to control and/or adjust the delivery rate and/or the delivery pressure, in particular the application rate and/or the application pressure at the spray nozzle, using one or more predeterminable duty cycles. In particular, distributing elements designed in this way are set up to open-loop control and/or to closed-loop control the delivery rate and/or the application rate by means of the adjustable pulse width and the delivery pressure and/or application pressure by means of the adjustable pulse frequency. In a particularly preferred embodiment of this type, it can be provided that the at least one operating parameter, in particular the rotation speed, of the conveying device is specified and/or set on the basis of the set duty cycle, in particular on the basis of the pulse width and/or pulse frequency, of the distributing elements. It is thus provided here that the at least one operating parameter, in particular the rotation speed, is varied based on the duty cycle of the distributing elements.

In a further development of the method according to the disclosure, the at least one operating parameter, in particular the rotation speed, of the conveying device is set to one of several, in particular determinable and/or retrievable, defined operating points, in particular defined rotation speeds. The defined operating points, in particular the defined rotation speeds, are each assigned to different opening times, in particular pulse durations or duty cycles. Preferably, the defined operating points, in particular rotation speeds, are also assigned to different delivery rates and/or delivery pressures. The different operating points, in particular rotation speeds, are preferably retrieved and/or determined or calculated using electronically stored function curves and/or characteristic maps. Each adjustable opening time or each duty cycle of the distributing elements and preferably each delivery rate and/or each delivery pressure is preferably assigned to at least one optimum operating point, in particular at least one optimum rotation speed. Alternatively or additionally, it may also be provided that a common operating point, in particular a common rotation speed, is assigned to different, in particular closely spaced, opening times or duty cycles.

In another preferred embodiment of the method according to the disclosure, the at least one operating parameter, in particular the rotation speed, of the conveying device is open-loop and/or closed-loop controlled within limit values which are preferably predeterminable and/or variable. The limit values are preferably adjusted as a function of the opening times, in particular pulse durations or duty cycles, the delivery rate and/or the delivery pressure. For example, the limit values can be stored electronically and/or specified and/or adjusted manually. In particular, it can also be provided here, that if the limit values are exceeded or not reached by the at least one operating parameter, in particular the rotation speed, than the respective opening times, the conveying quantities and/or conveying pressures are adjusted in such a way, that the at least one operating parameter, in particular the rotation speed, of the conveying device is corrected or changed in the direction of the limit values. Such limit values can be, for example, a maximum or minimum rotation speed of the pump device.

In a particularly preferred further development of the method according to the disclosure, at least one actuating element, in particular a flow control valve, provided for adjusting the delivery rate and/or the distributing elements, which are provided for adjusting the delivery pressure, are set and/or adjusted in such a way, that the at least one operating parameter, in particular the rotation speed, of the conveying device is set to one of the several defined operating points, in particular rotation speeds, which can be determined and/or called up. If a defined operating point, in particular a defined rotation speed, cannot be easily achieved in a certain situation during distributing, for example due to the travel speed of the spray device, it may in particular be provided that either the at least one actuating element or the distributing elements are set and/or adapted in such a way that the defined operating points, in particular rotation speeds, are achieved. Alternatively or additionally, it can also be provided that the at least one actuating element and the distributing elements are set and/or adapted together in such a way that the defined operating points, in particular rotation speeds, are reached. Furthermore, alternatively or additionally, it may also be provided, that the travel speed of the spray device is reduced or increased, for example by means of the “Tractor-Implement-Management” (TIM) protocol, in such a way that the defined operating points, in particular rotation speeds, are reached. At least one of the optimum operating points or rotation speeds can alternatively or additionally also be an operating point or rotation speed at which the conveying device comprises a particularly high efficiency or which is particularly advantageous in terms of wear and thus the service life (lifetime) and/or the energy requirement of the conveying device.

The task underlying the disclosure is further solved by an agricultural spray device, in particular a field sprayer with at least one associated open-loop and/or closed-loop control system, of the type mentioned at the beginning, wherein the spray device, in particular the open-loop and/or closed-loop control system, is designed to carry out the method according to the disclosure according to one of the embodiments described above. With regard to the advantages and modifications of the spray device according to the disclosure, reference is therefore made to the advantages and modifications of the method according to the disclosure.

### BRIEF DESCRIPTION OF THE DRAWING

Further details of the disclosure can be found in the exemplary description and the drawings. The drawing shows:

FIG. 1 is a schematic representation of a liquid plan of an agricultural spray device for carrying out a method according to at least one embodiment of the invention.

### DETAILED DESCRIPTION

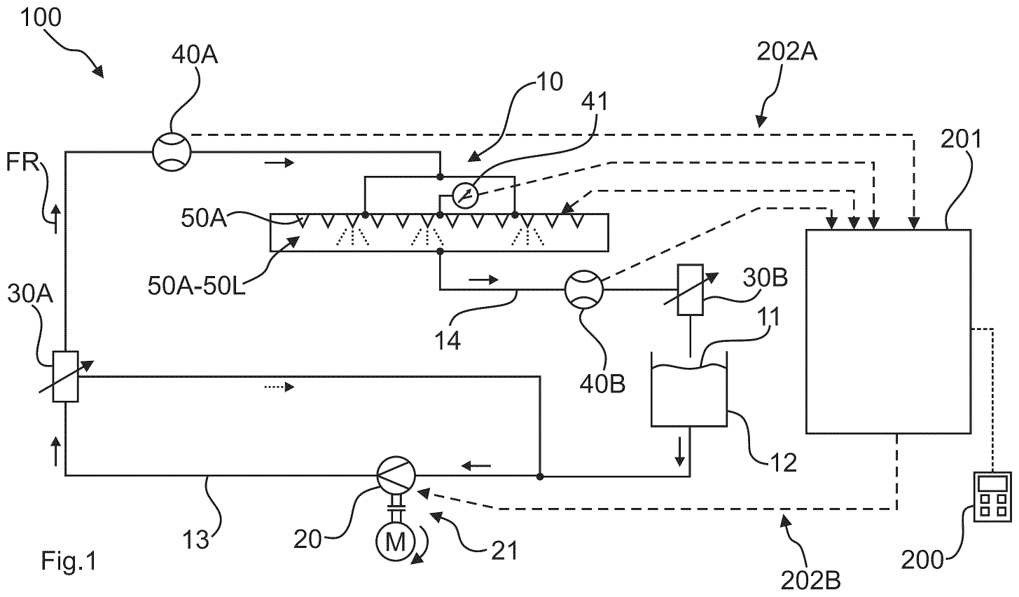

An exemplary structure of an agricultural spray device 100 designed as a field sprayer, which is intended for distributing a spray onto an agricultural area, is shown in FIG. 1. It should be explicitly mentioned here, that the spray device 100 can alternatively also be integrated within an agricultural distribution machine, such as a seed drill, a soil tillage machine or a plant treatment machine, such as a hoe.

The spray device 100 comprises here at least one liquid circuit 10, in which at least one reservoir 12 provided for holding the spray 11 to be distributed is integrated. The spray 11 is conveyed by at least one conveying device 20 designed as a pump device along liquid lines 13, 14 carrying the spray, which are subdivided in particular into at least one supply and return line. The conveying device 20 shown here is connected to the at least one storage container 12 via a suction side and is designed to suck the spray 11 from the storage container 12 and convey it in an adjustable manner along the liquid circuit 10. The spray 11 is conveyed on the basis of at least one operating parameter that can be set on the conveying device 20, preferably an adjustable rotation speed of the conveying device 20, in such a way that a defined delivery quantity and/or a defined delivery pressure is set at least in portions.

In addition to the exemplary embodiment shown, embodiments according to the invention are also conceivable, in which the spray device 100 alternatively or additionally comprises at least one further conveying device for conveying the spray 11. The at least one further conveying device, in particular designed as a pump device, can also be arranged along the at least one liquid circuit 10 and/or connected to the at least one storage container 12. Furthermore, it would also be conceivable that the at least one further conveying device is alternatively or additionally assigned to at least one further or other liquid circuit of the spray device 100. At least one conveying device can alternatively or additionally also be connected to an active ingredient delivery path, which is also not shown in this embodiment, e.g. in the manner of a so-called direct feed. In particular, it is intended here, that the conveying device is designed in the manner of piston diaphragm or centrifugal pumps.

As can also be seen in FIG. 1, the delivery rate or alternatively or additionally the delivery pressure is adjusted and/or influenced via optional actuators 30A, 30B, which are designed in the manner of flow control valves or proportional adjustment valves. In particular, it is provided that the delivery rate or alternatively or additionally the delivery pressure can be varied by means of an adjustable degree of opening of the actuators 30A, 30B. At least one of the actuators 30A, 30B, often referred to as central flow control valves, is arranged within the supply line 13, while the at least one other actuator 30B is arranged within the return line 14. The actuators 30A, 30B may of course also be arranged at other positions of the fluid circuit 10. Furthermore, an alternative embodiment with only one actuating element 30A, 30B is also conceivable.

Furthermore, optional measuring devices comprising volume flow meters 40A, 40B and a pressure sensor 41 are arranged along the fluid circuit 100. The respective measuring devices are designed to detect and/or determine either the delivery rate or the delivery pressure of the spray 11. Alternatively or additionally, at least one optional measuring device would also be conceivable, which is designed to detect and/or determine both the delivery rate and the delivery pressure of the spray together. At least one of the volume flow meters 40A, 40B shown is arranged within the supply line 13 of the liquid circuit 10, while the respective other volume flow meter 40b is arranged along the return line 14 of the liquid circuit 10. Alternatively or additionally, an embodiment with only one or more than two volume flow meters would also be conceivable.

In this case, the spray 11 is spread or distributed to the agricultural area via several distributing elements 50A-50L arranged along the liquid circuit 100. The distributing elements 50A-50L are designed in the manner of spray nozzles and/or spray nozzle valves and are arranged in an indicated conveying direction FR of the spray 11 downstream of the conveying device 30, in particular between the supply and return lines 13, 14. In addition, the distributing elements 50A-50L are each designed to adjust an application rate of the spray 11, in particular according to requirements and/or location, by means of opening times that can be set on the distributing elements 50A-50L. The necessary or needs-based application quantities can be called up, for example, on a sub-area and/or point-specific basis using a so-called electronically stored application map or the like.

Furthermore, it should be explicitly mentioned here, that the illustrated distributing elements 50A-50L in this embodiment example are particularly designed in the manner of fast-switching spray nozzles or nozzle valves often referred to as PWM or PWFM nozzles or valves. The distributing elements 50A-50L can be open-loop and/or closed-loop controlled at least partially or in groups or individually by means of pulse width modulation and/or pulse width frequency modulation and thus by means of an adjustable duty cycle. Usually, such distributing elements 50A-50L are arranged on a spray boom associated with the spray device 100, which is often mounted in a pendulum manner.

As can also be seen from the exemplary shown liquid plan, any not distributed or excess spray 11 is conveyed back to the storage tank 12 via the optional return line 14.

For conveying the spray 11, it is provided according to the disclosure that at least one operating parameter, in particular the rotation speed, of the conveying device 20 is open-loop and/or closed-loop controlled on the basis of the adjustable opening times, in particular the pulse duration or the duty cycle, of the distributing elements 50A-50L.

For this purpose, in particular an electronic computing unit 201 is provided, which is part of an open-loop and/or closed-loop control system 200 associated with the spray device 100. The computing unit 201 is connected here to the distributing elements 50A-50L and the conveying device 20 via schematically indicated signal lines 202A, 202B for data and signal transmission. The signal lines 202A, 202B can be at least partially wired and/or wireless. Thus, in order to determine and/or adjust at least one operating parameter, in particular the rotational speed, of the conveyor device 20, the opening times or the duty cycle of the dispensing elements 50A-50L are transmitted to the computing unit 201.

Furthermore, it is optionally provided that the at least one operating parameter of the conveying device 20 is additionally open-loop and/or closed-loop controlled on the basis of the delivery quantity and/or the delivery pressure. For this purpose, the electronic computing unit 201 is optionally connected via signal lines 202A to the measuring devices, in particular at least one volume flow meter 50A, 50B and/or a pressure sensor 41. It would also be conceivable that the conveying device 20, the distributing elements 50A-50L and/or the measuring devices are alternatively or additionally each assigned at least one separate electronic computing unit.

The at least one operating parameter of the conveying device 20 is defined below exclusively as the rotation speed of the conveying device 20, which is designed as a pump device, whereby alternatively or additionally other operating parameters, such as electrical voltage, current or the like, would also be conceivable. The conveying device 20 is driven by at least one associated actuator 21, which is designed to variably adjust the rotation speed of the conveying device 20. The actuator 21 can be designed, for example, in the form of a hydraulically, pneumatically and/or electrically operated motor. The motor 21 can also be a separate pump motor or pump drive. Alternatively or additionally, the conveying device 20 may also be operable by means of a power take-off drive of a tractor associated with the spray device 100.

Furthermore, it is provided that the rotation speed of the conveying device 20 is set to one of several, in particular determinable and/or retrievable, defined rotation speeds. The defined rotation speeds are assigned to different opening times or duty cycles and optionally also to different conveying quantities and/or conveying pressures. The defined rotation speeds of the conveying device can be determined, for example, using electronically stored and/or retrievable function curves or characteristic maps, which in particular define a relationship between the rotation speeds and opening times or duty cycles. In addition to the opening times or duty cycle, a relationship between the rotation speeds and the delivery rates and/or delivery pressures can also be defined using the function curves or maps. In other words, the necessary adjustable rotation speed for the conveying device 20 is determined directly on the basis of the opening times or duty cycle of the distributing elements 50A-50L. Depending on the embodiment, the duty cycle may be a duty cycle globally predetermined for all distributing elements 50A-50L or an average value of the duty cycles of several or all distributing elements 50A-50L.

In an alternative or additional embodiment, it may also be provided, that the rotation speed of the conveying device 20 is open-loop and/or closed-loop controlled within limit values, in particular predeterminable and/or variable limit values. The limit values are specified and/or varied depending on the opening times or duty cycle, the delivery rate and/or the delivery pressure. For example, a range of different permissible rotation speeds of the conveying device 20 can be predetermined for a certain duty cycle, of e.g. 80%, or a range of duty cycles, of e.g. 50% to 80%.

In an alternative embodiment, which is not shown in the figure, it would be quite conceivable, that at least one actuator 30A, 30B, in particular the degree of opening of the actuator 30A, 30B, and/or a travel speed of the spray device 100 is taken into account when determining and/or setting the rotation speed.

### List of Reference Numbers

10 Liquid circuit
11 Spray
12 Storage tank
13 Liquid line, supply line
14 Liquid line, return line
20 Conveying device
21 Actuators
100 Spray device
30A, 308 Actuator, flow control valve
40A, 408 Measuring device, volume flow meter
41 Measuring device, pressure sensor
50A-50L Distributing elements
200 Open-loop and/or closed-loop control system
201 Computing unit
202A, 2028 Signal lines

1. A method for distributing spray onto an agricultural area using an agricultural spray device, comprising the steps of
conveying the spray using at least one conveying device along at least one liquid circuit of the spray device, wherein a delivery rate and/or a delivery pressure, with which the spray is conveyed at least in portions along the liquid circuit, is set on the basis of at least one operating parameter which can be set on the conveying device; and
distributing the spray onto the agricultural area via a plurality of distributing elements arranged along the liquid circuit, which are each designed to adjust a distributing spray quantity according to demand and/or location, on the basis of opening times, which can be set on the distributing elements,
wherein the at least one operating parameter is open-loop and/or closed-loop controlled on the basis of the adjustable opening times, and on the basis of the delivery rate and/or the delivery pressure.

2. The method according to claim 1, wherein the distributing elements are open-loop and/or closed-loop controlled in the manner of pulse width modulation and/or pulse width frequency modulation.

3. The method according to claim 1, wherein the at least one operating parameter is set to one of a plurality of defined operating points, which can be determined and/or called up, the defined operating points being assigned in each case to different opening times and to different delivery quantities and/or delivery pressures.

4. The method according to claim 1, wherein the at least one operating parameter is open-loop and/or closed-loop controlled within limit values, which are predeterminable and/or variable, the limit values being adapted as a function of the opening times, the delivery rate and/or the delivery pressure.

5. The method according to claim 3, wherein at least one actuating element provided for adjusting a delivery quantity, and/or the distributing elements, which are provided for adjusting the delivery pressure, are set in such a way, that the at least one operating parameter is set to one of the plurality of determinable and/or retrievable, operating points.

6. A agricultural spray device having at least one associated open-loop and/or closed-loop control system, wherein the spray device is configured to carry out the method according to claim 1.

7. The method according to claim 1, wherein the at least one conveying device is pump device.

8. The method according to claim 1, wherein the opening times are based on a pulse duration or a duty cycle of the distributing elements.

9. The method according to claim 1, wherein at least one operating parameter is a rotation speed of the conveying device.

10. The method according to claim 3, wherein the plurality of defined operating points are defined rotation speeds.

11. The method according to claim 3, wherein the different opening times are pulse durations or duty cycles.

12. The method according to claim 1, wherein the agricultural spray device is a field sprayer.
